(19) United States
(12) Patent Application Publication
(10) Pub. No.: US 2025/0374264 A1
(43) Pub. Date: Dec. 4, 2025

(54) Methods For Enhanced Uplink Control Information Multiplexing In Mobile Communications

(71) Applicant: MediaTek Inc., Hsinchu City (TW)

(72) Inventors: Jozsef Gabor Nemeth, Cambridge (GB); Sylvio Paul Mathieu Bardes, Cambridge (GB); Mohammed S Aleabe Al-Imari, Cambridge (GB); Pradeep Jose, Cambridge (GB)

(21) Appl. No.: 19/216,774

(22) Filed: May 23, 2025

Related U.S. Application Data
(60) Provisional application No. 63/653,363, filed on May 30, 2024.

(51) Int. Cl. H04W 72/1263; H04L 1/1829; H04W 72/232

(52) U.S. Cl. CPC H04W 72/1263; H04L 1/1861; H04W 72/232

(57) ABSTRACT

Various solutions for enhanced uplink control information (UCI) multiplexing in mobile communications are described. An apparatus may receive a downlink control information (DCI) from a network node. The DCI schedules one or more physical uplink shared channels (PUSCHs). The apparatus may multiplex UCI to one of the PUSCHs carrying uplink shared channel (UL-SCH) data. The multiplexing starts from a symbol position determined according to at least one of the following: a dynamic signaling comprising an indication of the symbol position; one or more user equipment (UE) processing timelines for reporting the UCI; and a position of a demodulation reference signal (DMRS) symbol configured by the DCI. Then, the apparatus may transmit the PUSCHs to the network node.

### CROSS REFERENCE TO RELATED PATENT APPLICATION(S)

The present disclosure is part of a non-provisional application claiming the priority benefit of U.S. Patent Application No. 63/653,363, filed 30 May 2024, the content of which herein being incorporated by reference in its entirety.

### TECHNICAL FIELD

The present disclosure is generally related to mobile communications and, more particularly, to enhanced uplink control information (UCI) multiplexing in mobile communications.

### BACKGROUND

Unless otherwise indicated herein, approaches described in this section are not prior art to the claims listed below and are not admitted as prior art by inclusion in this section.

In 4^{th} generation (4G) Long-Term Evolution (LTE) or 5^{th} generation (5G) New Radio (NR), downlink control information (DCI) may include scheduling information for user equipment (UE) to receive or transmit data via scheduled network resources. More specially, based on a downlink (DL) DCI, the UE may receive physical downlink shared channel(s) (PDSCH(s)) from a base station (BS); and based on an UL DCI, the UE may transmit physical uplink shared channel(s) (PUSCH(s)) carrying uplink shared channel (UL-SCH) data to the BS. In addition, uplink control information (UCI), such as hybrid automatic repeat request (HARQ) feedback corresponding to the PDSCH(s) reception, and/or channel state information (CSI) report, etc., may be transmitted to the BS over configured physical uplink control channel(s) (PUCCH(s)), or may be multiplexed to the PUSCH(s) to be transmitted to the BS along with the UL-SCH data.

However, with mobile communication technology advancing (e.g., in 6^{th} generation (6G)), more component carriers (CC's) need to be scheduled within the same or tightened hard-real-time (HRT) processing requirements. For example, in 5G, HARQ feedback multiplexing to (UL-SCH) data lies on the critical path of the HRT computation path, because the HARQ codebook payload is updated after the PDSCH decoding. Also, UE processing timelines, including N1 (i.e., the time span that the UE requires to process the received PDSCH) and N2 (i.e., the time span that the UE requires to prepare PUSCH), generally apply in 5G as an additional scheduling timing constraint for UE and BS. Furthermore, 5G also specifies certain aperiodic-CSI (A-CSI) reporting scenarios, where the UE processing timelines Z and Z′ are as strict as the UE processing timelines for HARQ feedback multiplexing (i.e., the values are similar between the following pairs of requirements: Z˜N2, Z′˜N1). Accordingly, in 6G, the UE processing timelines may need to be reduced to achieve lower scheduling and retransmission latencies.

Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to enhanced UCI multiplexing in mobile communications. It is believed that the above-described issue would be avoided or otherwise alleviated by implementing one or more of the proposed schemes described herein.

In one aspect, a method may involve an apparatus receiving a DCI from a network node, wherein the DCI schedules one or more PUSCHs. The method may also involve the apparatus multiplexing UCI to one of the PUSCHs carrying UL-SCH data, wherein the multiplexing starts from a symbol position determined according to at least one of the following: a dynamic signaling comprising an indication of the symbol position; one or more UE processing timelines for reporting the UCI; and a position of a demodulation reference signal (DMRS) symbol configured by the DCI. The method may further involve the apparatus transmitting the PUSCHs to the network node.

In one aspect, a method may involve a network node transmitting a DCI to an apparatus, wherein the DCI schedules one or more PUSCHs. The method may further involve the network node receiving the PUSCHs carrying UL-SCH data from the apparatus, wherein the PUSCHs have UCI multiplexed thereto starting from a symbol position determined according to at least one of the following: a dynamic signaling comprising an indication of the symbol position; one or more UE processing timelines for reporting the UCI; and a position of a DMRS symbol configured by the DCI.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of UCI multiplexing to PUSCH in 5G NR.

FIG. 2 is a diagram depicting an example scenario of UCI encoding and modulation for mapping/multiplexing to PUSCH in 5G NR.

FIG. 3 is a diagram depicting an example scenario of a communication environment in which various solutions and schemes in accordance with the present disclosure may be implemented.

FIG. 4 is a diagram depicting an example scenario of UCI multiplexing to PUSCH in accordance with an implementation of the present disclosure.

FIG. 5 is a diagram depicting another example scenario of UCI multiplexing to PUSCH in accordance with an implementation of the present disclosure.

FIG. 6 is a diagram depicting an example scenario of UCI multiplexing to PUSCH in accordance with an implementation under the fifth sub-proposal of the present disclosure.

FIG. 7 is a diagram depicting an example scenario of UCI multiplexing to PUSCH in accordance with an implementation under the sixth sub-proposal of the present disclosure.

FIG. 8 is a diagram depicting an example scenario of DCI content with HARQ-ACK codebook selection reference(s) in accordance with an implementation under the seventh sub-proposal of the present disclosure.

FIG. 9 is a diagram depicting an example scenario of DCI content with HARQ-ACK codebook scheduling reference(s) in accordance with an implementation under the eighth sub-proposal of the present disclosure.

FIG. 10 is a diagram depicting an example scenario of UCI multiplexing to PUSCH in accordance with an implementation under the eighth sub-proposal of the present disclosure.

FIG. 11 is a block diagram of an example communication system in accordance with an implementation of the present disclosure.

FIG. 12 is a flowchart of an example process in accordance with an implementation of the present disclosure.

FIG. 13 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhanced UCI multiplexing in mobile communications. According to the present disclosure, a number of possible solutions may be implemented separately or jointly. That is, although these possible solutions may be described below separately, two or more of these possible solutions may be implemented in one combination or another.

In the present disclosure, the terminology “UCI” is used to denote HARQ feedback (e.g., HARQ-acknowledgement (ACK) or non-acknowledgement (NACK) and/or any other UCI (e.g., CSI and scheduling request (SR), etc.) that might be scheduled at Layer-1 (L1) (as opposed to reporting by Layer-2 (L2) as UL medium access control-control element (MAC-CE), i.e., part of the transport block (TB)). The terminology “timeline” stands for UE processing timeline (e.g., N1 and N2). In codebook-based HARQ, the feedback may be organized into a predefined structure known as a “codebook”, where the ACK/NACK information for PDSCH reception is compactly represented, and this method enables efficient feedback for scenarios where there are multiple PDSCH receptions or code block group (CBG)-based retransmissions. On the other hand, non-codebook-based HARQ provides feedback in a simpler, more straightforward manner, with one bit of ACK/NACK typically transmitted per TB or transmission.

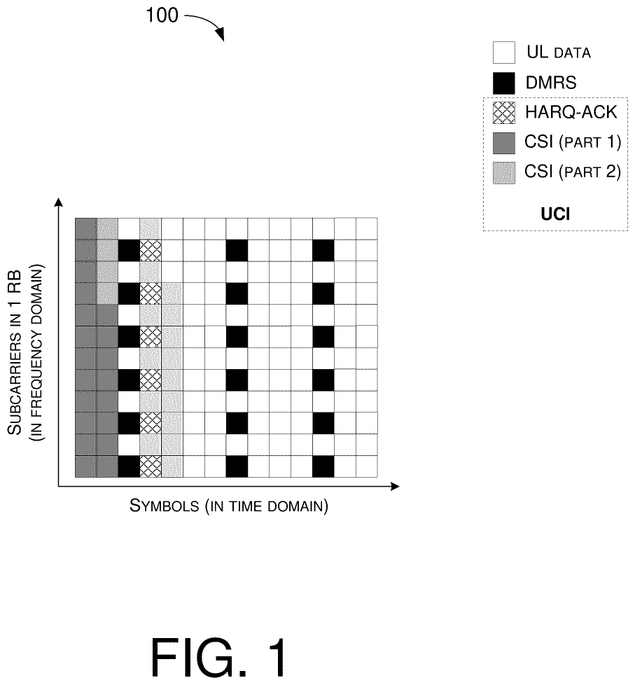

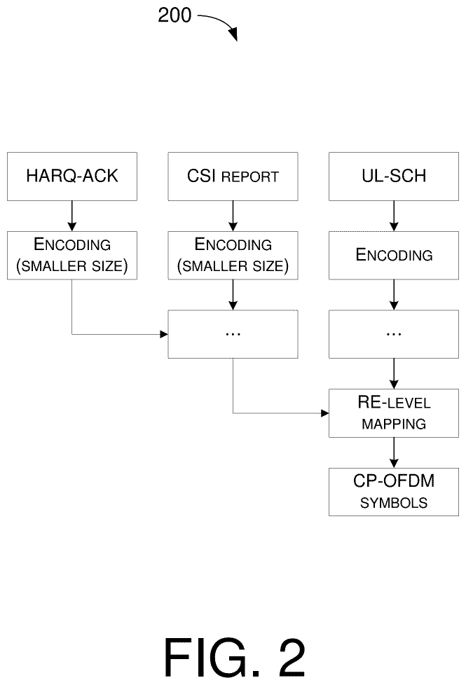

In 5G NR, UCI is multiplexed to PUSCH by taking resource elements (REs) that are meant to be allocated for UL-SCH and giving them to UCI. FIG. 1 illustrates an example scenario 100 of UCI multiplexing to PUSCH in 5G NR. As shown in FIG. 1, for maximum robustness, the HARQ feedback (e.g., HARQ-ACK) is mapped close to the DMRS, and for minimal latency, UCI (including HARQ-ACK, CSI, and/or SR) is mapped close to the start of PUSCH. In one example, if all UCI cannot be mapped close to the first DMRS, then predefined table(s) may be used to determine how the mapping continues near to the second, etc. DMRS. For the mapping/multiplexing, UCI encoding and modulation at the UE side may be performed separately from that of UL-SCH data, and they may be decoded independently at the BS side, too. FIG. 2 illustrates an example scenario 200 of UCI encoding and modulation for mapping/multiplexing to PUSCH in 5G NR. In one example, UCI transmission may need to be robust with a single shot transmission (i.e., no retransmission available) using a lower code-rate and quadrature phase shift keying (QPSK) modulation, whereas UL-SCH data may be retransmitted by HARQ process (without UCI). In short, UCI multiplexing to PUSCH may have certain benefits, such as (i) shared DMRS may contribute to less channel estimation for BS, and (ii) UCI transmission may become more spectrally efficient. However, as above-described, the issue with the tight HRT processing requirements for UCI multiplexing to PUSCH remains to be solved in 6G.

In view of the above, the present disclosure proposes a number of schemes pertaining to enhanced UCI multiplexing in mobile communications. According to the proposed schemes of the present disclosure, when UCI is multiplexed (by UE) to PUSCH carrying UL-SCH data, the symbol where the mapping/multiplexing starts may be determined explicitly by dynamic signaling (e.g., through DCI), and/or implicitly by predetermined rule(s) (e.g., based on the end of the applicable UE processing timeline(s), and/or the position of DMRS symbols scheduled by the same DCI). More specifically, the proposed schemes of the present disclosure assume that UCI needs to be mapped close to a DMRS symbol to be robust. Accordingly, by applying the proposed schemes of the present disclosure, signaling overhead may be minimized and scheduling flexibility may be improved, while ensuring that the mapping/multiplexing meets the tight HRT processing requirements.

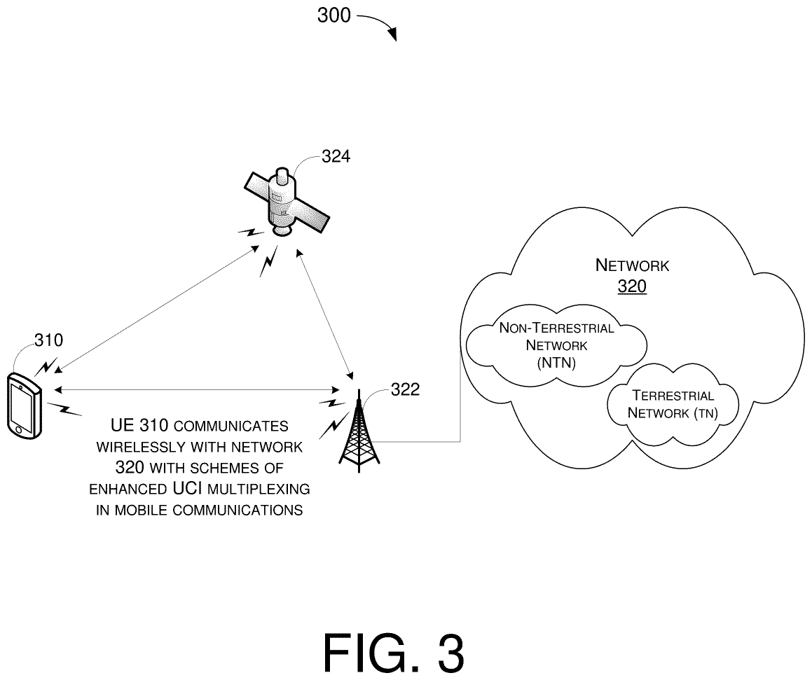

FIG. 3 illustrates an example scenario 300 of a communication environment in which various solutions and schemes in accordance with the present disclosure may be implemented. Scenario 300 involves a UE 310 in wireless communication with a network 320 (e.g., a wireless network including a non-terrestrial network (NTN) and a TN) via a terrestrial network node 322 (e.g., a BS such as an evolved Node-B (eNB), a Next Generation Node-B (gNB), a transmission/reception point (TRP), or a gateway) and/or a non-terrestrial network node 324 (e.g., a satellite). For example, the terrestrial network node 322 and/or the non-terrestrial network node 324 may form an NTN/TN serving cells for wireless communication with the UE 310. In such communication environment, the UE 310, the network 320, and the terrestrial network node 322 and/or the non-terrestrial network node 324 may implement various schemes pertaining to enhanced UCI multiplexing in mobile communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

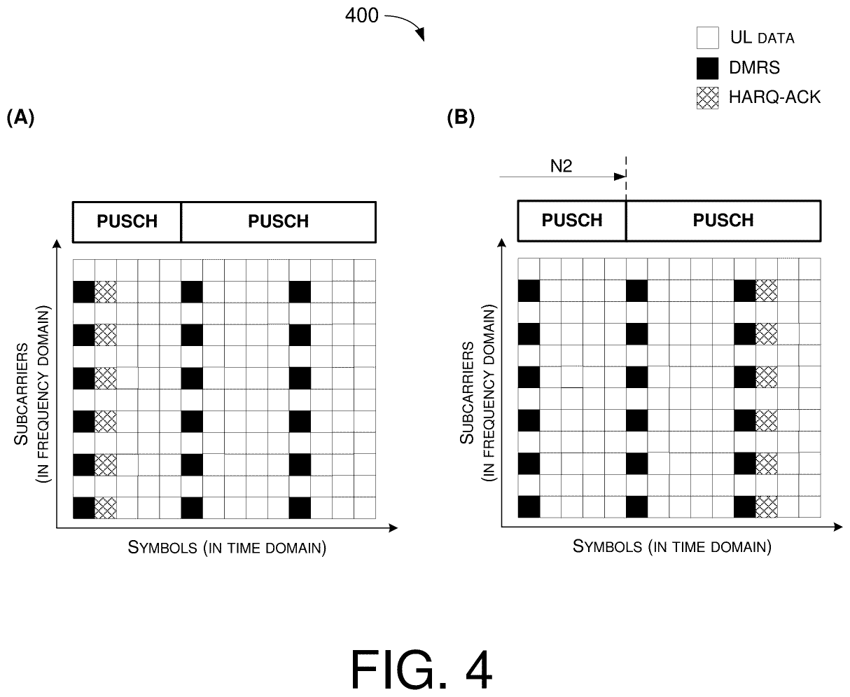

FIG. 4 illustrates an example scenario 400 of UCI multiplexing to PUSCH in accordance with an implementation of the present disclosure. Part (A) of FIG. 4 depicts the case of mapping/multiplexing the UCI (e.g., HARQ-ACK) next to the first DMRS of the scheduled PUSCHs. Part (B) of FIG. 4 depicts the case of mapping/multiplexing the UCI (e.g., HARQ-ACK) next to the third DMRS of the scheduled PUSCHs. In this implementation, it is assumed that the UCI can only be mapped to symbols without DMRS.

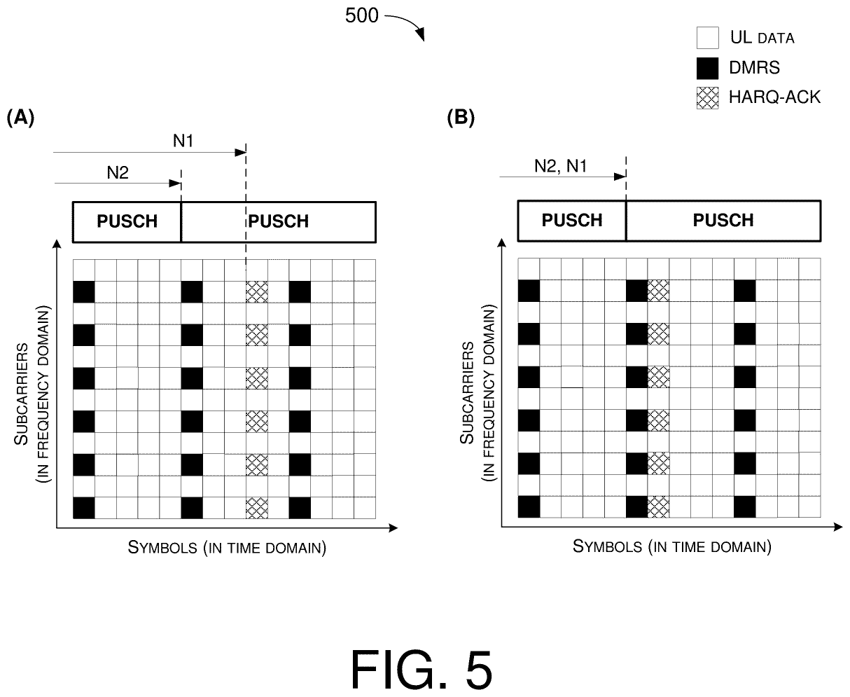

FIG. 5 illustrates an example scenario 500 of UCI multiplexing to PUSCH in accordance with an implementation of the present disclosure. Part (A) of FIG. 5 depicts the case of mapping/multiplexing the UCI (e.g., HARQ-ACK) to the first symbol, that meets the UE processing timeline N1, in the first PUSCH that meets the UE processing timeline N2. Part (B) of FIG. 5 depicts the case of mapping/multiplexing the UCI (e.g., HARQ-ACK) to the first symbol without DMRS in the first PUSCH that meets the UE processing timelines N1 and N2. In this implementation, it is assumed that the UCI can only be mapped to symbols without DMRS.

In some implementations, the UCI may also be mapped/multiplexed onto cyclic prefix-orthogonal frequency division multiplexing (CP-OFDM) symbols containing DMRS.

In some implementations, the UCI may be mapped/multiplexed only onto symbols not containing DMRS.

In some implementations, the UE processing timeline N2 must be met by the PUSCH that contains the REs carrying the UCI.

In some implementations, the UE processing timeline N1 must be met by the PUSCH that contains the REs carrying the UCI.

In some implementations, the UE processing timeline N1 must only be met by the symbol that contains the REs carrying the UCI.

In some implementations, the earliest feasible symbol (abiding by the N1, N2 timelines and DMRS rules) may be used as the starting symbol.

In some implementations, the earliest feasible symbol (abiding by the N1, N2 timeline rules) next a DMRS may be used as the starting symbol.

In some implementations, the DCI may indicate which symbol is used, by either referring to the symbol or the DMRS relative to the symbol.

In some implementations, the DCI may indicate which PUSCH to carry the UCI (e.g., for the case of multiple PUSCHs being configured).

In some implementations, the starting symbol or the DMRS symbol may be indexed starting from the first symbol after the DCI.

In some implementations, the starting symbol or the DMRS symbol may be indexed starting from the first symbol after the end of the UE processing timeline N2.

In some implementations, the starting symbol or the DMRS symbol may be indexed starting from the first symbol after the next DL-UL switching point in the give CC.

In some implementations, the symbol may be indicated as a DMRS index and symbol-offset value.

Under a first sub-proposal of the present disclosure, the HARQ feedback may be encoded separately from (UL-SCH) data and CSI, and may be modulated separately from (UL-SCH) data. In one example, HARQ feedback and any CSI multiplexed at L1 may use QPSK modulation, and the respective code rates may be indicated dynamically, possibly using indexing to preconfigured tables (e.g., the respective parameter in NR is called beta_ACK) by radio resource control (RRC) signaling. In one example, potentially, CSI, too may be encoded separately from data (as in NR), but it is also possible that most CSI reports are sent via MAC-CE and only some CSI is scheduled at L1. For instance, A-CSI scenarios with short latency requirements may be scheduled and multiplexed at L1, whereas the other CSI may be carried by MAC-CE.

Under a second sub-proposal of the present disclosure, CSI report with short computation delay requirement may be encoded separately from other CSI, HARQ-ACK and (UL-SCH) data. In certain scenarios, the CSI computation delay requirement is on par with UE processing timeline (as it is the case in NR, too), and a combination of conditions, regarding no other CSI computation is on-going, DMRS based CSI measurements, wideband channel quality indication (CQI), and channel feedback, etc., may be taken into account. In one example, CSI may be encoded separately from (UL-SCH) data and other UCI if certain conditions are met, such as: (i) short CSI computation delay requirement; (ii) no other CSI computation performed in parallel; (iii) DMRS-based A-CSI reporting; (iv) only wideband CQI is reported; (v) only the channel response is reported (in some basis).

Under a third sub-proposal of the present disclosure, a DCI may schedule multiple PUSCHs in subsequent symbols, and the scheduled PUSCHs may share DMRS (i.e. some PUSCHs may have DMRS, while other PUSCHs may not have DMRS). It is noted that in 5G NR, a single DCI schedules a single TB per-PUSCH, whereas in the present disclosure (e.g., in 6G), multiple TBs may be scheduled per UL DCI. For example, in 6G, an UL DCI may schedule multiple TBs or CBGs, which are typically 1 symbol each (except for coverage limited cases).

Under a fourth sub-proposal of the present disclosure, DCI may indicate the DMRS symbol where the UCI (e.g., HARQ-ACK) mapping/multiplexing starts relative to the first DMRS symbol or relative to the first DMRS symbol that abides by all UE processing timelines N1 and N2 and CSI computation delays. In one example, for discrete Fourier transform-spread (DFT-S)-OFDM system, the UCI (e.g., HARQ-ACK) may be mapped onto the symbol following the DMRS symbol. In one example, the UE processing timelines may need to be abided by in all cases, and if necessary for this condition to hold, an offset of one or more symbols is applied with respect to indicated DMRS symbol. The offset may be either predefined by rules or indicated as an additional field (e.g. over 1-2 bits) in DCI. For instance, a separate field (e.g. a single bit) may indicate the offset in unit of symbol(s) with respect to the end of the UE processing timeline N1/N2.

Under a fifth sub-proposal of the present disclosure, the UE may determine the DMRS symbol where the UCI (e.g., HARQ-ACK) mapping/multiplexing starts based on the UE processing timelines N1 and N2. In one example, for DFT-S-OFDM system, the UCI (e.g., HARQ-ACK) may be mapped onto the symbol following the DMRS symbol.

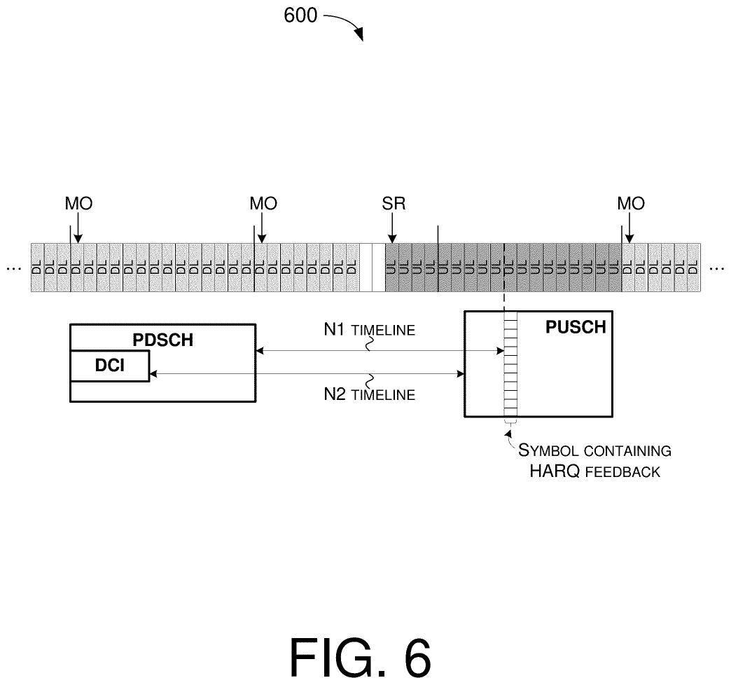

FIG. 6 illustrates an example scenario 600 of UCI multiplexing to PUSCH in accordance with an implementation under the fifth sub-proposal of the present disclosure. As shown in FIG. 6, a monitoring occasion (MO) is configured for detecting DCI in the first symbol of each slot. When a DCI scheduling a PDSCH is detected, the UE performs PDSCH reception based on the DCI. There are two UE processing timelines related to reporting HARQ feedback of the PDSCH reception, including N1 timeline (i.e., the time span that the UE requires to process the received PDSCH to generate corresponding HARQ feedback) and N2 timeline (i.e., the time span that the UE requires to prepare for the configured PUSCH), and the starting symbol of UCI multiplexing to PUSCH abides by these UE processing timelines.

Under a sixth sub-proposal of the present disclosure, the UCI (e.g., HARQ-ACK codebook) may be split into two for encoding and sending based on UE processing timeline N1 or UCI size limitation. In one example, the UL DCI may indicate the size of UCI that is to be multiplexed to PUSCH carrying UL-SCH data. If the indicated UCI size is smaller than the UCI payload, the UCI may get segmented, with the first part being transmitted in currently scheduled PUSCH and the remaining parts being transmitted later when UCI is scheduled again for sending (e.g., the first part needs to be acknowledged before rescheduling).

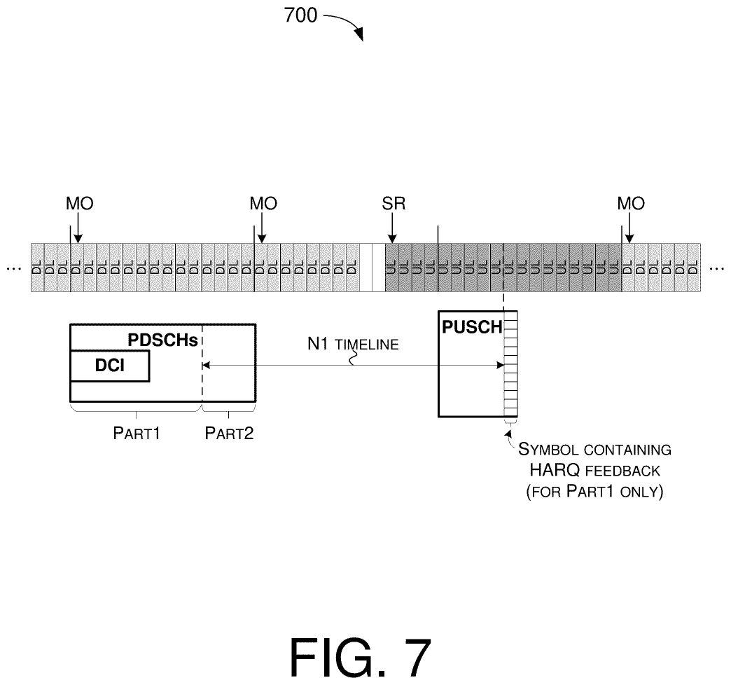

FIG. 7 illustrates an example scenario 700 of UCI multiplexing to PUSCH in accordance with an implementation under the sixth sub-proposal of the present disclosure. As shown in FIG. 7, when a DCI scheduling PDSCHs is detected in a configured MO, the UE performs PDSCH receptions based on the DCI. More specifically, the HARQ-ACK codebook is split into Part1 and Part2 based on the UE processing timeline N1, and only Part1 is transmitted in the recently configured PUSCH, e.g., due to UCI size limitation. In one example, Part2 may be automatically scheduled to the following HARQ-ACK codebook having a predictable identifier, e.g., the HARQ-ACK codebook-counter field is incremented on each new codebook (which will be addressed by the next sub-proposal in a more explicit way).

Under a seventh sub-proposal of the present disclosure, separate (Type-2) HARQ-ACK codebooks may be selected for each PDSCH or each group of PDSCH. In one example, a DL DCI (section) may contain a reference to a HARQ-ACK codebook per each PDSCH that it schedules. In one example, the DL DCI (section) may contain at most two references to a (Type-2) HARQ-ACK codebook. In one example, Part2 of the HARQ-ACK codebook may be automatically scheduled to the following HARQ-ACK codebook having a predictable identifier, e.g., the HARQ-ACK codebook-counter field is incremented on each new codebook, and a single reference is sufficient for this case.

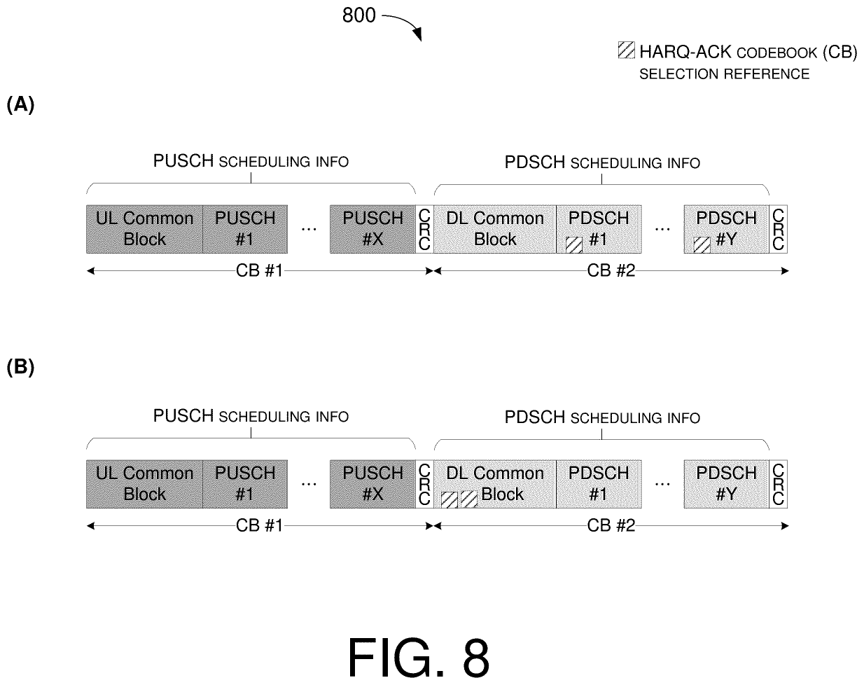

FIG. 8 illustrates an example scenario 800 of DCI content with HARQ-ACK codebook selection reference(s) in accordance with an implementation under the seventh sub-proposal of the present disclosure. Part (A) of FIG. 8 depicts the case of introducing a reference field for HARQ-ACK codebook selection per PDSCH, where each reference field indicates an association between one PDSCH and a HARQ-ACK codebook used for UCI multiplexing. Part (B) of FIG. 8 depicts the case of introducing at most one or two reference fields for HARQ-ACK codebook selection for all PDSCHs (e.g., only one reference field for all PDSCHs, or only two reference fields and the HARQ-ACK codebook selection for the following PDSCHs can be inferred based on the two reference fields). In one example, a DCI field may specify the boundary between the groups of PDSCHs. In one example, the indicated UCI size and/or the UE processing timeline N1 may establish the boundary between the groups of PDSCHs.

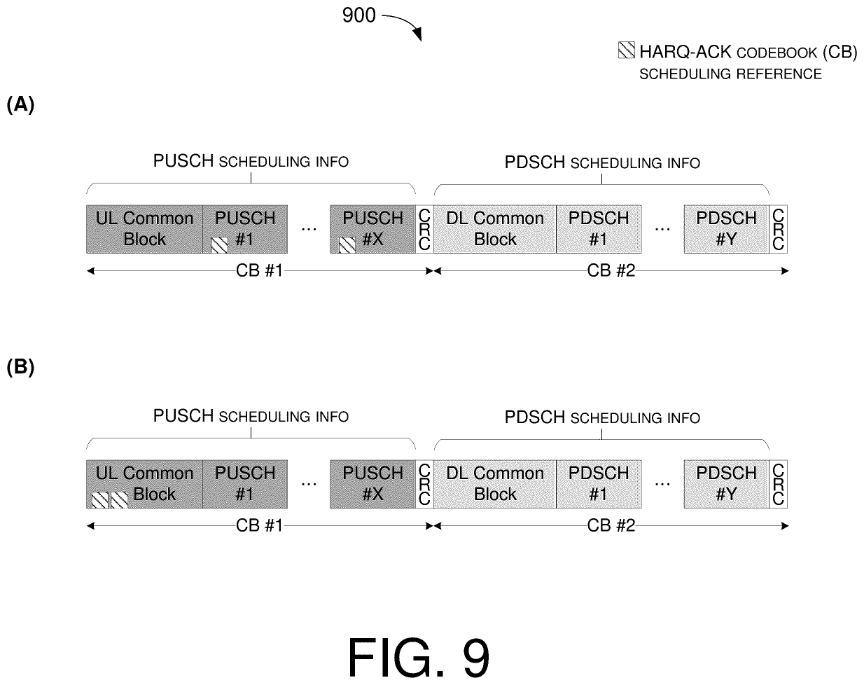

Under an eighth sub-proposal of the present disclosure, multiple HARQ-ACK codebooks may be scheduled by the same UL DCI. FIG. 9 illustrates an example scenario 900 of DCI content with HARQ-ACK codebook scheduling reference(s) in accordance with an implementation under the eighth sub-proposal of the present disclosure. Part (A) of FIG. 9 depicts the case of introducing a reference field for HARQ-ACK codebook scheduling per PUSCH (i.e., the reference fields for HARQ-ACK codebooks are part of the scheduling information that is repeated per PUSCH), where each reference field indicates an association between one PUSCH and a HARQ-ACK codebook used for UCI multiplexing. In this case, the DCI may indicate on which PUSCH the UCI is multiplexed onto. Part (B) of FIG. 9 depicts the case of introducing one or at most two reference fields for HARQ-ACK codebook scheduling for all PUSCHs (i.e., at most two HARQ-ACK codebooks may be multiplexed and the common UL block of the DCI may have 2 reference fields to select HARQ-ACK codebooks for UCI multiplexing). In this case, the UE processing timeline(s) may be used to determine which PUSCH/symbol the HARQ feedback gets multiplexed onto.

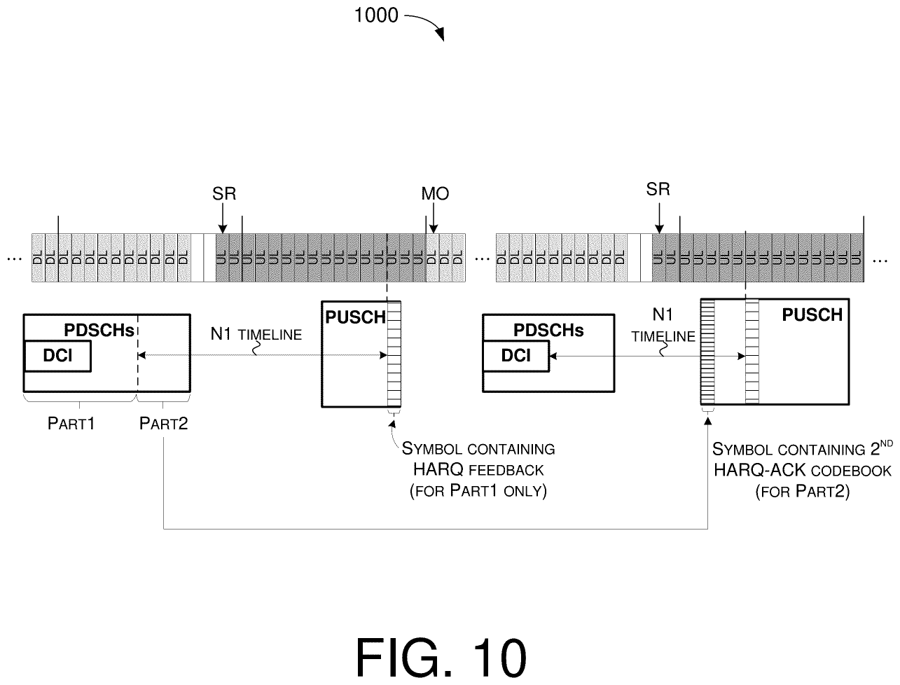

FIG. 10 illustrates an example scenario 1000 of UCI multiplexing to PUSCH in accordance with an implementation under the eighth sub-proposal of the present disclosure. Scenario 1000 depicts the case where the first HARQ-ACK codebook originates from a split. Specifically, the first HARQ-ACK codebook contains the HARQ feedback corresponding to the first part of the scheduled PDSCHs, and is transmitted in the PUSCH scheduled by the same DCI. The remaining HARQ feedback corresponding to the second part of the scheduled PDSCHs is contained in the second HARQ-ACK codebook, and is transmitted in another PUSCH scheduled by a later DCI.

Under a nineth sub-proposal of the present disclosure, UCI mapping/multiplexing to PUSCH in frequency domain may be performed by distributing UCI over the frequency span of the TB allocated for the PUSCH. In one example, the HARQ-ACK bits may be mapped by equal spacing over available REs indexed by j*d, j=0,1,2, . . . , where e.g., for the last HARQ-ACK bit j_max*d≤maxRE*bitPerRE but j_max*(d+1)>maxRE*bitPerRE.

### Illustrative Implementations

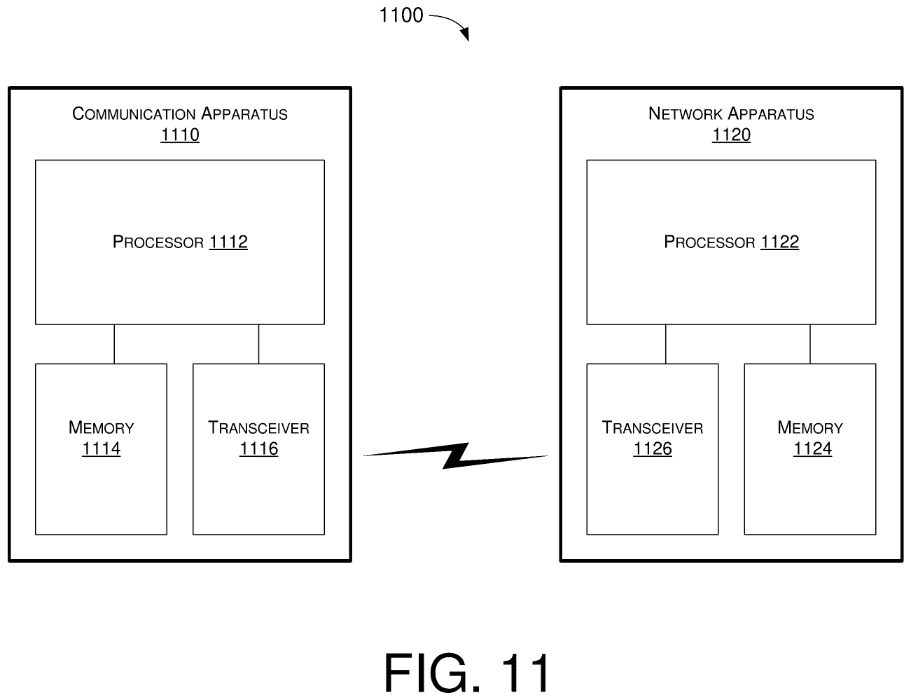

FIG. 11 illustrates an example communication system 1100 having an example communication apparatus 1110 and an example network apparatus 1120 in accordance with an implementation of the present disclosure. Each of communication apparatus 1110 and network apparatus 1120 may perform various functions to implement schemes, techniques, processes and methods described herein pertaining to enhanced UCI multiplexing in mobile communications, including scenarios/schemes described above as well as processes 1200 and 1300 described below.

Communication apparatus 1110 may be a part of an electronic apparatus, which may be a UE such as a portable or mobile apparatus, a wearable apparatus, a wireless communication apparatus or a computing apparatus. For instance, communication apparatus 1110 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 1110 may also be a part of a machine type apparatus, which may be an IoT, NB-IoT, or IIoT UE such as an immobile or a stationary apparatus, a home apparatus, a roadside unit (RSU), a wire communication apparatus or a computing apparatus. For instance, communication apparatus 1110 may be implemented in a smart thermostat, a smart fridge, a smart door lock, a wireless speaker or a home control center. Alternatively, communication apparatus 1110 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1110 may include at least some of those components shown in FIG. 11 such as a processor 1112, for example. Communication apparatus 1110 may further include one or more other components not pertinent to the proposed scheme of the present disclosure (e.g., internal power supply, display device and/or user interface device), and, thus, such component(s) of communication apparatus 1110 are neither shown in FIG. 11 nor described below in the interest of simplicity and brevity.

Network apparatus 1120 may be a part of an electronic apparatus, which may be a network node such as a satellite, a BS, a cell, a router or a gateway of a wireless network (e.g., 4G, 5G, or 6G network). For instance, network apparatus 1120 may be implemented in a satellite or an eNB/gNB/TRP in a 4G/5G/6G, NR, IoT, NB-IoT or IIoT network. Alternatively, network apparatus 1120 may be implemented in the form of one or more IC chips such as, for example and without limitation, one or more single-core processors, one or more multi-core processors, or one or more RISC or CISC processors. Network apparatus 1120 may include at least some of those components shown in FIG. 11 such as a processor 1122, for example. Network apparatus 1120 may further include one or more other components not pertinent to the proposed scheme of the present disclosure (e.g., internal power supply, display device and/or user interface device), and, thus, such component(s) of network apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks, including enhanced UCI multiplexing, in a device (e.g., as represented by communication apparatus 1110) and a network node (e.g., as represented by network apparatus 1120) in accordance with various implementations of the present disclosure.

In some implementations, communication apparatus 1110 may also include a transceiver 1116 coupled to processor 1112 and capable of wirelessly transmitting and receiving data. In some implementations, transceiver 1116 may be capable of wirelessly communicating with different types of UEs and/or wireless networks of different radio access technologies (RATs). In some implementations, transceiver 1116 may be equipped with a plurality of antenna ports (not shown) such as, for example, four antenna ports. That is, transceiver 1116 may be equipped with multiple transmit antennas and multiple receive antennas for multiple-input multiple-output (MIMO) wireless communications. In some implementations, network apparatus 1120 may also include a transceiver 1126 coupled to processor 1122. Transceiver 1126 may include a transceiver capable of wirelessly transmitting and receiving data. In some implementations, transceiver 1126 may be capable of wirelessly communicating with different types of UEs of different RATs. In some implementations, transceiver 1126 may be equipped with a plurality of antenna ports (not shown) such as, for example, four antenna ports. That is, transceiver 1126 may be equipped with multiple transmit antennas and multiple receive antennas for MIMO wireless communications.

In some implementations, communication apparatus 1110 may further include a memory 1114 coupled to processor 1112 and capable of being accessed by processor 1112 and storing data therein. In some implementations, network apparatus 1120 may further include a memory 1124 coupled to processor 1122 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 1110 and network apparatus 1120 may be a communication entity capable of communicating with each other using various proposed schemes in accordance with the present disclosure. For illustrative purposes and without limitation, a description of capabilities of communication apparatus 1110, as a UE, and network apparatus 1120, as a network node, is provided below with processes 1200 and 1300.

### Illustrative Processes

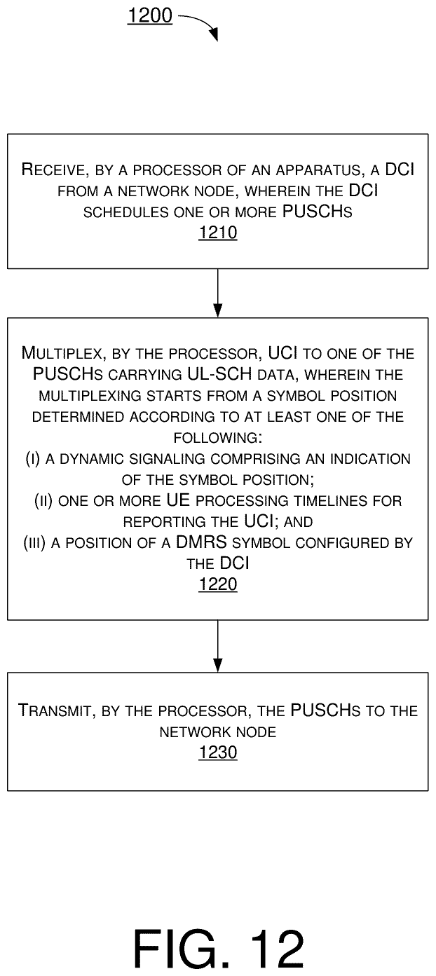

FIG. 12 illustrates an example process 1200 in accordance with an implementation of the present disclosure. Process 1200 may be an example implementation of above scenarios/schemes, whether partially or completely, with respect to enhanced UCI multiplexing in mobile communications. Process 1200 may represent an aspect of implementation of features of communication apparatus 1110. Process 1200 may include one or more operations, actions, or functions as illustrated by one or more of blocks 1210 to 1230. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by or in communication apparatus 1110 or any suitable UE or machine type device. Solely for illustrative purposes and without limitation, process 1200 is described below in the context of communication apparatus 1110, as a UE, and network apparatus 1120, as a network node (e.g., BS). Process 1200 may begin at block 1210.

At block 1210, process 1200 may involve processor 1112 of communication apparatus 1110, receiving, via transceiver 1116, a DCI from network apparatus 1120, wherein the DCI schedules one or more PUSCHs. Process 1200 may proceed from block 1210 to block 1220.

At block 1220, process 1200 may involve processor 1112 multiplexing UCI to one of the PUSCHs carrying UL-SCH data, wherein the multiplexing starts from a symbol position determined according to at least one of the following: (i) a dynamic signaling comprising an indication of the symbol position; (ii) one or more UE processing timelines for reporting the UCI; and (iii) a position of a DMRS symbol configured by the DCI. Process 1200 may proceed from block 1220 to block 1230.

At block 1230, process 1200 may involve processor 1112 transmitting, via transceiver 1116, the PUSCHs to the network node.

In some implementations, the DMRS symbol may be the first symbol containing DMRS in the PUSCHs, and the UCI may be multiplexed next to the DMRS symbol. Alternatively, the DMRS symbol may be the second symbol containing DMRS in the first PUSCH that meets the one or more UE processing timelines, and the UCI may be multiplexed next to the DMRS symbol. Alternatively, the DMRS symbol may be the first symbol in the PUSCHs, that meets the one or more UE processing timelines, and the UCI may be multiplexed to the DMRS symbol. Alternatively, the DMRS symbol may be the first symbol not containing DMRS in the first PUSCH that meets the one or more UE processing timelines, and the UCI may be multiplexed to the DMRS symbol.

In some implementations, the UCI may be multiplexed to one or more symbols containing DMRS or may be multiplexed only to one or more symbols not containing DMRS.

In some implementations, the dynamic signaling may include the DCI, and the indication may indicate the symbol position or indicate another symbol position as a reference of the symbol position.

In some implementations, the DCI may indicate which one of the one or more PUSCHs to carry the UCI.

In some implementations, the symbol position may be indexed from a first symbol subsequent to the DCI, or may be indexed starting from a first symbol subsequent to an end of the one or more UE processing timelines, or may be indicated as a DMRS index and a symbol offset value.

In some implementations, the UCI may include at least one of a HARQ feedback and CSI, and the HARQ feedback may be encoded separately from the CSI and the UL-SCH data and may be modulated separately from the UL-SCH data, or the CSI with short computation delay requirement may be encoded separately from other CSI, the HARQ feedback and the UL-SCH data.

In some implementations, the PUSCHs may be scheduled in subsequent symbols, some of which contain DMRS shared by the PUSCHs.

In some implementations, the multiplexing of the UCI may include: multiplexing some of the UCI to the PUSCH that meets the one or more UE processing timelines in an event that a size for UCI indicated by the DCI is smaller than a size of the UCI; and multiplexing rest of the UCI to another PUSCH scheduled by a later DCI.

In some implementations, the DCI may include a DL DCI scheduling one or more PDSCHs corresponding to the UCI and an UL DCI scheduling the PUSCHs, and the DL DCI may include one or more references, each indicating an association between one of the PDSCHs and a HARQ-ACK codebook used for UCI multiplexing, or the UL DCI may include one or more references, each indicating an association between one of the PUSCHs and a HARQ-ACK codebook used for UCI multiplexing.

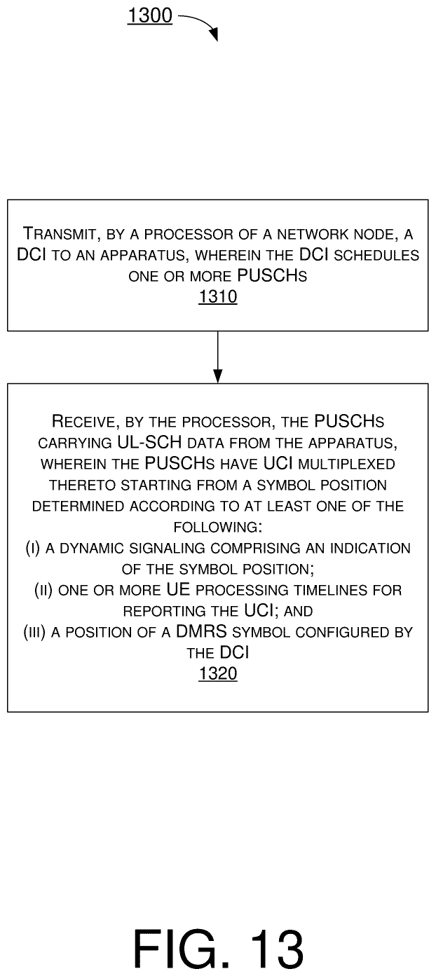

FIG. 13 illustrates an example process 1300 in accordance with an implementation of the present disclosure. Process 1300 may be an example implementation of above scenarios/schemes, whether partially or completely, with respect to enhanced UCI multiplexing in mobile communications. Process 1300 may represent an aspect of implementation of features of network apparatus 1120. Process 1300 may include one or more operations, actions, or functions as illustrated by one or more of blocks 1310 and 1320. Although illustrated as discrete blocks, various blocks of process 1300 may be divided into additional blocks, combined into fewer blocks, or eliminated, depending on the desired implementation. Moreover, the blocks of process 1300 may be executed in the order shown in FIG. 13 or, alternatively, in a different order. Process 1300 may be implemented by or in network apparatus 1120 as well as any variations thereof. Solely for illustrative purposes and without limitation, process 1300 is described below in the context of communication apparatus 1110, as a UE, and network apparatus 1120, as a network node (e.g., BS). Process 1300 may begin at block 1310.

At block 1310, process 1300 may involve processor 1122 of network apparatus 1120, transmitting, via transceiver 1126, a DCI to communication apparatus 1110, wherein the DCI schedules one or more PUSCHs. Process 1300 may proceed from block 1310 to block 1320.

At block 1320, process 1300 may involve processor 1122 receiving, via transceiver 1126, the PUSCHs carrying UL-SCH data from communication apparatus 1110, wherein the PUSCHs have UCI multiplexed thereto starting from a symbol position determined according to at least one of the following: (i) a dynamic signaling comprising an indication of the symbol position; (ii) one or more UE processing timelines for reporting the UCI; and (iii) a position of a DMRS symbol configured by the DCI.

In some implementations, the DMRS symbol may be the first symbol containing DMRS in the PUSCHs, and the UCI may be multiplexed next to the DMRS symbol. Alternatively, the DMRS symbol may be the second symbol containing DMRS in the first PUSCH that meets the one or more UE processing timelines, and the UCI may be multiplexed next to the DMRS symbol. Alternatively, the DMRS symbol may be the first symbol in the PUSCHs, that meets the one or more UE processing timelines, and the UCI may be multiplexed to the DMRS symbol. Alternatively, the DMRS symbol may be the first symbol not containing DMRS in the first PUSCH that meets the one or more UE processing timelines, and the UCI may be multiplexed to the DMRS symbol.

In some implementations, the UCI may be multiplexed to one or more symbols containing DMRS or may be multiplexed only to one or more symbols not containing DMRS.

In some implementations, the dynamic signaling may include the DCI, and the indication may indicate the symbol position or indicate another symbol position as a reference of the symbol position.

In some implementations, the DCI may indicate which one of the one or more PUSCHs to carry the UCI.

In some implementations, the symbol position may be indexed from a first symbol subsequent to the DCI, or may be indexed starting from a first symbol subsequent to an end of the one or more UE processing timelines, or may be indicated as a DMRS index and a symbol offset value.

In some implementations, the UCI may include at least one of a HARQ feedback and CSI, and the HARQ feedback may be encoded separately from the CSI and the UL-SCH data and may be modulated separately from the UL-SCH data, or the CSI with short computation delay requirement may be encoded separately from other CSI, the HARQ feedback and the UL-SCH data.

In some implementations, the PUSCHs may be scheduled in subsequent symbols, some of which contain DMRS shared by the PUSCHs.

In some implementations, the UCI may be multiplexed to the PUSCHs in a way that: some of the UCI may be multiplexed to the PUSCH that meets the one or more UE processing timelines in an event that a size for UCI indicated by the DCI is smaller than a size of the UCI; and rest of the UCI may be multiplexed to another PUSCH scheduled by a later DCI.

In some implementations, the DCI may include a DL DCI scheduling one or more PDSCHs corresponding to the UCI and an UL DCI scheduling the PUSCHs, and the DL DCI may include one or more references, each indicating an association between one of the PDSCHs and a HARQ-ACK codebook used for UCI multiplexing, or the UL DCI may include one or more references, each indicating an association between one of the PUSCHs and a HARQ-ACK codebook used for UCI multiplexing.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI) from a network node, wherein the DCI schedules one or more physical uplink shared channels (PUSCHs);
multiplexing, by the processor, uplink control information (UCI) to one of the PUSCHs carrying uplink shared channel (UL-SCH) data, wherein the multiplexing starts from a symbol position determined according to at least one of the following:
a dynamic signaling comprising an indication of the symbol position;
one or more user equipment (UE) processing timelines for reporting the UCI; and
a position of a demodulation reference signal (DMRS) symbol configured by the DCI; and
transmitting, by the processor, the PUSCHs to the network node.

2. The method of claim 1, wherein:
the DMRS symbol is the first symbol containing DMRS in the PUSCHs, and the UCI is multiplexed next to the DMRS symbol;
the DMRS symbol is the second symbol containing DMRS in the first PUSCH that meets the one or more UE processing timelines, and the UCI is multiplexed next to the DMRS symbol;
the DMRS symbol is the first symbol in the PUSCHs, that meets the one or more UE processing timelines, and the UCI is multiplexed to the DMRS symbol; or
the DMRS symbol is the first symbol not containing DMRS in the first PUSCH that meets the one or more UE processing timelines, and the UCI is multiplexed to the DMRS symbol.

3. The method of claim 1, wherein the UCI is multiplexed to one or more symbols containing DMRS or is multiplexed only to one or more symbols not containing DMRS.

4. The method of claim 1, wherein the dynamic signaling comprises the DCI, and the indication indicates the symbol position or indicates another symbol position as a reference of the symbol position.

5. The method of claim 1, wherein the DCI indicates which one of the one or more PUSCHs to carry the UCI.

6. The method of claim 1, wherein the symbol position is indexed from a first symbol subsequent to the DCI, or is indexed starting from a first symbol subsequent to an end of the one or more UE processing timelines, or is indicated as a DMRS index and a symbol offset value.

7. The method of claim 1, wherein the UCI comprises at least one of a hybrid automatic repeat request (HARQ) feedback and channel state information (CSI), and the HARQ feedback is encoded separately from the CSI and the UL-SCH data and is modulated separately from the UL-SCH data, or the CSI with short computation delay requirement is encoded separately from other CSI, the HARQ feedback and the UL-SCH data.

8. The method of claim 1, wherein the PUSCHs are scheduled in subsequent symbols, some of which contain DMRS shared by the PUSCHs.

9. The method of claim 1, wherein the multiplexing of the UCI comprises:
multiplexing some of the UCI to the PUSCH that meets the one or more UE processing timelines in an event that a size for UCI indicated by the DCI is smaller than a size of the UCI; and
multiplexing rest of the UCI to another PUSCH scheduled by a later DCI.

10. The method of claim 1, wherein the DCI comprises a DL DCI scheduling one or more physical downlink shared channels (PDSCHs) corresponding to the UCI and an UL DCI scheduling the PUSCHs, and the DL DCI comprises one or more references, each indicating an association between one of the PDSCHs and a hybrid automatic repeat request-acknowledgement (HARQ-ACK) codebook used for UCI multiplexing, or the UL DCI comprises one or more references, each indicating an association between one of the PUSCHs and a HARQ-ACK codebook used for UCI multiplexing.

11. A method, comprising:
transmitting, by a processor of a network node, a downlink control information (DCI) to an apparatus, wherein the DCI schedules one or more physical uplink shared channels (PUSCHs); and
receiving, by the processor, the PUSCHs carrying uplink shared channel (UL-SCH) data from the apparatus, wherein the PUSCHs have uplink control information (UCI) multiplexed thereto starting from a symbol position determined according to at least one of the following:
a dynamic signaling comprising an indication of the symbol position;
one or more user equipment (UE) processing timelines for reporting the UCI; and
a position of a demodulation reference signal (DMRS) symbol configured by the DCI.

12. The method of claim 11, wherein:
the DMRS symbol is the first symbol containing DMRS in the PUSCHs, and the UCI is multiplexed next to the DMRS symbol;
the DMRS symbol is the second symbol containing DMRS in the first PUSCH that meets the one or more UE processing timelines, and the UCI is multiplexed next to the DMRS symbol;
the DMRS symbol is the first symbol in the PUSCHs, that meets the one or more UE processing timelines, and the UCI is multiplexed to the DMRS symbol; or
the DMRS symbol is the first symbol not containing DMRS in the first PUSCH that meets the one or more UE processing timelines, and the UCI is multiplexed to the DMRS symbol.

13. The method of claim 11, wherein the UCI is multiplexed to one or more symbols containing DMRS or is multiplexed only to one or more symbols not containing DMRS.

14. The method of claim 11, wherein the dynamic signaling comprises the DCI, and the indication indicates the symbol position or indicates another symbol position as a reference of the symbol position.

15. The method of claim 11, wherein the DCI indicates which one of the one or more PUSCHs to carry the UCI.

16. The method of claim 11, wherein the symbol position is indexed from a first symbol subsequent to the DCI, or is indexed starting from a first symbol subsequent to an end of the one or more UE processing timelines, or is indicated as a DMRS index and a symbol offset value.

17. The method of claim 11, wherein the UCI comprises at least one of a hybrid automatic repeat request (HARQ) feedback and channel state information (CSI), and the HARQ feedback is encoded separately from the CSI and the UL-SCH data and is modulated separately from the UL-SCH data, or the CSI with short computation delay requirement is encoded separately from other CSI, the HARQ feedback and the UL-SCH data.

18. The method of claim 11, wherein the PUSCHs are scheduled in subsequent symbols, some of which contain DMRS shared by the PUSCHs.

19. The method of claim 11, wherein the UCI is multiplexed to the PUSCHs in a way that:
some of the UCI is multiplexed to the PUSCH that meets the one or more UE processing timelines in an event that a size for UCI indicated by the DCI is smaller than a size of the UCI; and
rest of the UCI is multiplexed to another PUSCH scheduled by a later DCI.

20. The method of claim 11, wherein the DCI comprises a DL DCI scheduling one or more physical downlink shared channels (PDSCHs) corresponding to the UCI and an UL DCI scheduling the PUSCHs, and the DL DCI comprises one or more references, each indicating an association between one of the PDSCHs and a hybrid automatic repeat request-acknowledgement (HARQ-ACK) codebook used for UCI multiplexing, or the UL DCI comprises one or more references, each indicating an association between one of the PUSCHs and a HARQ-ACK codebook used for UCI multiplexing.
